(19) United States
(12) Patent Application Publication
(10) Pub. No.: US 2008/0183774 A1
(43) Pub. Date: Jul. 31, 2008

(54) CONTROL DEVICE AND METHOD FOR DATA MIGRATION BETWEEN NAS DEVICES

(75) Inventors: Toshio OTANI, Kawasaki (JP); Atsushi UEOKA, Machida (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 11/971,285

(22) Filed: Jan. 9, 2008

(30) Foreign Application Priority Data
Jan. 26, 2007 (JP) 2007-016163

(51) Int. Cl. G06F 17/30

(52) U.S. Cl. 707/204; 707/E17.001

(57) ABSTRACT

All the data in the source directory of the NAS device 2000 is copied to the destination directory of the NAS device 3000. During this time the NAS device 2000 receives added/modified data to the source directory. After the copy is completed, copying (differential data copy) of the data corresponding to the differential that is generated in the source directory is executed. Differential data copying is continued until the required copying time is less than a predetermined time. The NAS device 2000 suspends access from the client 4000, and copies a final differential data to the NAS device 3000. The NAS device 3000 starts to receive access from the client 4000.

### CROSS-REFERENCE TO PRIOR APPLICATION

This application relates to and claims the benefit of priority from Japanese Patent Application number 2007-16163, filed on Jan. 26, 2007 the entire disclosure of which is incorporated herein by reference.

### BACKGROUND

The present invention relates to technology for copying data stored in a first NAS device to a second NAS device.

The technology known as Network Attached Storage (NAS) in which data is accessed by a plurality of computers is becoming common. According to NAS, data stored in a storage device (hereafter referred to as “NAS device”) is shared among a plurality of host computers. In this case, the NAS device and the host computers are connected by a predetermined protocol, generally a protocol referred to as Network File System (NFS) or Common Internet File System (CIFS).

The data is normally stored long term (for example, several years through several tens of years, depending on the circumstances several hundreds of years). In this case, the storage period exceeds the life of the NAS device or the legal service life, and due to technical advances and so on the need to replace an existing NAS device with a new NAS device arises. In other words, the need to migrate data between NAS devices arises.

Three technologies, for example, are known for migrating data between NAS devices.

The first technology is disclosed in, for example, Japanese Patent Application Laid-open No. 2003-173279. In the first technology, when a destination NAS device receives an unmigrated data Read request from a client (host computer), the destination NAS device acquires the unmigrated data On-demand from the source NAS device (in other words, the unmigrated data is transferred to itself), and a response is returned to the client. Also, the client stores newly added data and/or newly modified data (hereafter referred to as added/modified data) as it is in the destination NAS device.

The second technology is disclosed in, for example, Japanese Patent Application Laid-open No. 2006-164211. In the second technology, an intermediate switch connecting the destination NAS device, the source NAS device, and the client is provided. The intermediate switch migrates the data from the source NAS device to the destination NAS device. The client accesses the intermediate switch, the intermediate switch acquires the necessary data from the NAS device where the data is stored, and transmits the data to the client.

The third technology is disclosed in, for example, Japanese Patent Application Laid-open No. 2005-292952. In the third technology, data is exchanged at block level. Data is migrated from the source NAS device to the destination NAS device at block level.

The first through third technologies described above have, for example, the following problems.

(a) There is a problem with migration safety. Specifically, in the first and second technologies, added/modified data (for example, the latest data) is on the destination NAS device, so if the migration is suspended for any reason, the restoration operation to restore the original is difficult.

(b) Compatibility with a heterogeneous environment is not possible. In other words, at least one of the source NAS device and the destination NAS device is limited. Specifically, in the third technology, data is copied at block level, so there must be compatibility between the source NAS device and the destination NAS device. For example, it is necessary that the file system be the same, so if the vendors or models of the source NAS device and the destination NAS device are different, it is not possible to migrate the data. Also, in the first technology, it is necessary to use a destination NAS device having the function of being able to migrate On-demand the unmigrated data, so the destination NAS device is limited.

(c) It is expensive to create an environment for migrating data. Specifically, in the second technology, a dedicated expensive switch is necessary. The software and switch used when migrating data is generally designed for Hierarchical Storage Management (HSM) or virtualization uses, and are not removed after migration of the data, and are expensive (for example, maintenance cost).

### SUMMARY

Therefore, it is an object of the present invention to achieve data migration between NAS devices without the necessity of compatibility between the source NAS device and the destination NAS device, at low cost and safely.

Other objects of the present invention will become clear after the explanation.

The device that controls the migration of data from a first NAS device to a second NAS device includes a copy execution unit and a copy control unit. The copy execution unit carries out an initial data copy by reading an initial data group comprising all the data stored in a first storage area of the first NAS device from the first storage area and writing the initial data group to a second storage area of the second NAS device, and after the initial data copy or a differential data copy is completed, carries out a differential data copy by reading a differential data group comprising one or more data corresponding to the differential from the data group read in the previous initial data copy or differential data copy, from the first storage area and writes the differential data group to the second storage area. The copy control unit determines whether data fixing conditions are satisfied at least every time a differential data copy is completed, and if the data fixing conditions are satisfied, causes the first NAS device to suspend writing from a client device to the first storage area, and causes the copy execution unit to execute a final differential data copy.

Each of the above units may be constructed in hardware, software, or a combination of the two (for example, a part may be realized with a computer program, and the remainder realized with hardware). A computer program is read by a predetermined processor and executed. Also, when information processing is carried out after the processor reads the computer program, memory or a recording area on a hardware resource may be used. Also, the computer program may be installed on a computer from a CD-ROM or another recording medium, or may be downloaded to a computer via a communication network.

### BRIEF DESCRIPTION OF THE DRAWINGS

FIG. 1 shows an example of computer system according to a first embodiment of the present invention;

FIG. 2 shows an example of the configuration of a NAS device according to the first embodiment of the present invention;

FIG. 3 shows an example of the configuration of the migration server according to the first embodiment of the present invention;

FIG. 4 shows an example of NAS share information and NAS mount information according to the first embodiment of the present invention;

FIG. 5 shows an example of the process flow of data migration according to the first embodiment of the present invention;

FIG. 6 shows an example of data within the source directory prior to the initial copy according to the first embodiment of the present invention;

FIG. 7 shows an example of data within the source directory after the initial copy, and data within the destination directory prior to the initial copy according to the first embodiment of the present invention;

FIG. 8 shows an example of service stop and switching process flow according to the first embodiment of the present invention;

FIG. 9 shows a modified example of computer system according to the first embodiment of the present invention;

FIG. 10 shows a modified example of the configuration of a NAS device according to the first embodiment of the present invention;

FIG. 11 shows an example of data input screen for estimating according to the first embodiment of the present invention;

FIG. 12 shows an example of results output screen for estimating according to the first embodiment of the present invention;

FIG. 13 shows an example of the estimating process flow according to the first embodiment of the present invention;

FIG. 14 shows an example of the process flow executed by the adjusting function of the data migration program according to a second embodiment of the present invention; and

FIG. 15 is a diagram to explain data migration according to a third embodiment of the present invention.

### DESCRIPTION OF THE PREFERRED EMBODIMENTS

The following is an explanation of several embodiments of the present invention. In the following explanation, not only is all the data (including added/modified data) in the source NAS device copied to the destination NAS device, but also data migration is completed when the destination NAS device can be accessed by the client for any and all of the data. A source NAS is the NAS device which has original data to be transferred to destination NAS. A destination NAS is the NAS device which receives and stores data from source NAS.

### First Embodiment

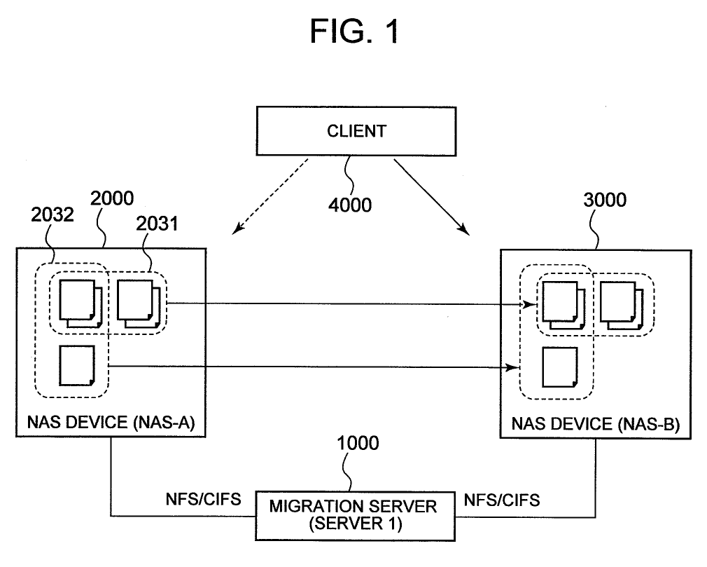

FIG. 1 is a diagram showing an example of computer system according to a first embodiment of the present invention.

The system includes a migration server 1000 that executes data migration between NAS devices, a NAS device 2000 that is the source NAS device, a NAS device 3000 that is the destination NAS device, and a client 4000 that accesses the NAS devices 2000 and 3000 via NFS and/or CIFS (hereafter referred to as “NFS/CIFS”).

The NAS device 2000 has data 2031 that is to be migrated, and the data 2031 is shared by NFS/CIFS. The migration server 1000 has mounted the NAS device 2000 shared directory by NFS/CIFS, so the data 2031 can be read. In parallel, the migration server 1000 has mounted the NAS device 3000 shared directory by NFS/CIFS, so data 2031 from the NAS device 2000 can be read, and written to the NAS device 3000. In other words, the data 2031 can be copied. The data 2031 is all the data stored in the source directory of the NAS device 2000 prior to starting to copy. Therefore, the main copying carried out initially is referred to as the “initial copy”.

While an initial copy is being executed, the NAS device 2000 is accessed (Read and/or Write) by the client 4000 by NFS/CIFS. As a result, while the data 2031 is being copied, data 2032 is generated in the NAS device 2000 corresponding to the added and/or modified (hereafter referred to as “added/modified”) files. In other words, the data 2032 is the difference between the NAS device 3000 after the initial copy is completed and the NAS device 2000. Therefore, the data 2032 is sometimes referred to below as the differential data 2032, and sometimes also referred to as the added/updated data 2032.

After copying the data 2031 has been completed, the migration server 1000 immediately (or after a fixed period of time has passed) copies the differential data 2032 from the start of copying the data 2031 until the present. Hereafter this copying operation is called the “differential data copy”, in contrast to the initial copy referred to previously.

During this differential data copy, the NAS device 2000 continues to be accessed by the client 4000. After the differential data copy is completed, the migration server 1000 checks whether the required copying time (the length of time required for the differential data copy) is less than a predetermined permitted resuming time (for example, 10 hours). If the required copying time is not less than the predetermined permitted resuming time, and if new differential data has been generated in the NAS device 2000 during the first differential data copy, the migration server 1000 carries out a second differential data copy to copy the new differential data. The migration server 1000 continues to repeat this differential data copy until the required copying time for the differential copy is less than the permitted resuming time.

When it is found that the required copying time is less than the permitted resuming time, the migration server 1000 issues a command to shut down access to the NAS device 2000 from the client 4000. In response to this command, the NAS device 2000 shuts off access from the client 4000 (for example, stops receiving write requests as a minimum), and fixes the data (in other words, does not permit new added/modified data to be generated). Then, the migration server 1000 copies the added/modified data of the NAS device 2000 to the NAS device 3000 (in other words, executes a final differential data copy). Finally, the NAS device 3000 receives access from the client 4000. In this way, data migration according to the present embodiment is completed.

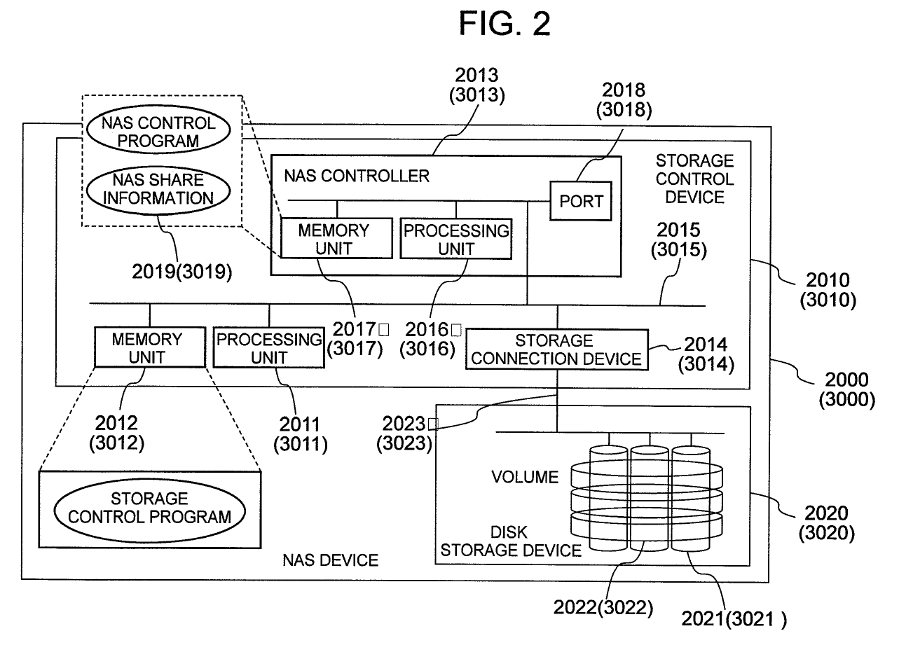

FIG. 2 shows an example of the configuration of NAS devices 2000 and 3000. In the present embodiment the configuration of the NAS device 2000 and the configuration of the NAS device 3000 are the same. Therefore in FIG. 2 the elements of the NAS device 2000 are given reference numerals without parentheses, and the elements of the NAS device 3000 are given reference numerals with parentheses. However, the configurations of the NAS device 2000 and the NAS device 3000 are not necessarily the same. Specifically, the vendors and model types for NAS devices 2000 and 3000 may be different, for example.

The NAS device 2000 (3000) includes a storage control device 2010 (3010) that controls data I/O (access), and a disk storage device 2020 (3020) in which a group of disks that store data is disposed, connected by a bus 2023 (3023).

The storage control device 2010 (3010) includes a processing unit 2011 (3011) formed by a CPU or similar, a memory unit 2012 (3012) that includes memory or similar, a NAS controller 2013 (3013) that processes access by NFS/CIFS, and a storage connection device 2014 (3014) connected to the disk storage device 2020 (3020), each connected to a bus 2015 (3015). The memory unit 2012 (3012) stores a storage control program. The storage control program is a computer program. By executing the storage control program in the processing unit 2011 (3011), processes relating to access to a logical volume 2022 that is described later, and storage I/O and so on are executed. Hereafter, when the computer program is the subject, processes are actually carried out by the processing unit (for example, a CPU) executing the computer program.

The NAS controller 2013 (3013) includes a processing unit 2016 (3016) that includes a CPU or similar, a memory unit 2017 (3017) that includes memory or similar, and a port 2018 (3018) that has an IP network connection function. The memory unit 2017 (3017) stores a NAS control program that carries out control processes related to NFS/CIFS, and NAS Share information 2019 (3019) that indicates what directories are shared with what clients. The NAS control program is executed by the processing unit 2016 (3016).

The disk storage device 2020 (3020) includes a group of disks 2021 (3021) constituted by a disk devices such as hard disk drives, and so on. The group of disks 2021 (3021) is connected to the storage connection device 2014 (3014) by the bus 2023 (3023). The group of disks 2021 (3021) includes one or more Redundant Array of Independent (or Inexpensive) Disks (RAID) groups, and each RAID group includes two or more disk devices, a RAID configuration such as RAID 5 or the like being adopted. A logical volume 2022 (3022) known as a logical unit (LU) is formed based on the memory space of each RAID group. Information (for example, the logical unit number (LUN) of each logical volume 2022 (3022), memory capacity, and so on) regarding each logical volume 2022 (3022) is controlled by the storage control program.

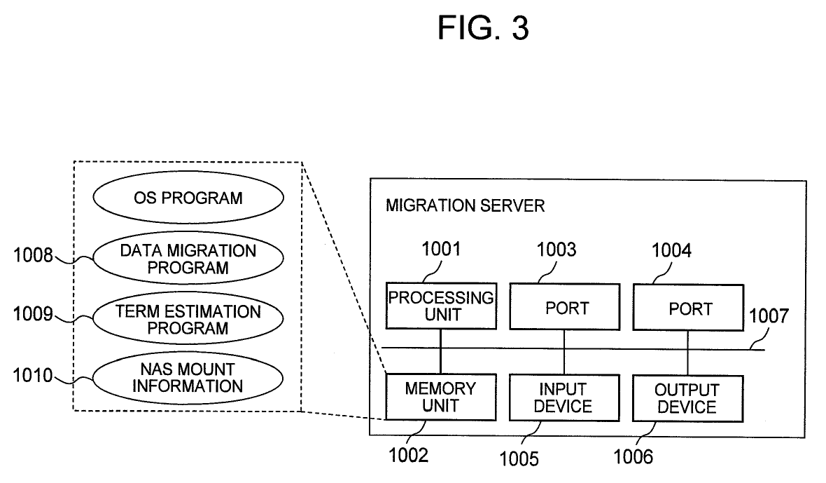

FIG. 3 shows an example of the configuration of the migration server 1000.

The migration server 1000 includes a processing unit 1001 such as a CPU or similar, a memory unit 1002 such as memory or similar, ports 1003, 1004 having an IP network function, an input device 1005 such as a keyboard or similar, an output device 1006 such as a display or similar, and a bus 1007 to which these elements are connected. The memory unit 1002 stores an operating system (OS) program (an OS such as Windows (registered trademark), Linux, or similar), a data migration program 1008 that is described later, a migration term estimation program 1009, and NAS mount information 1010. The OS program and the other computer programs 1008, 1009 are executed by the processing unit 1001.

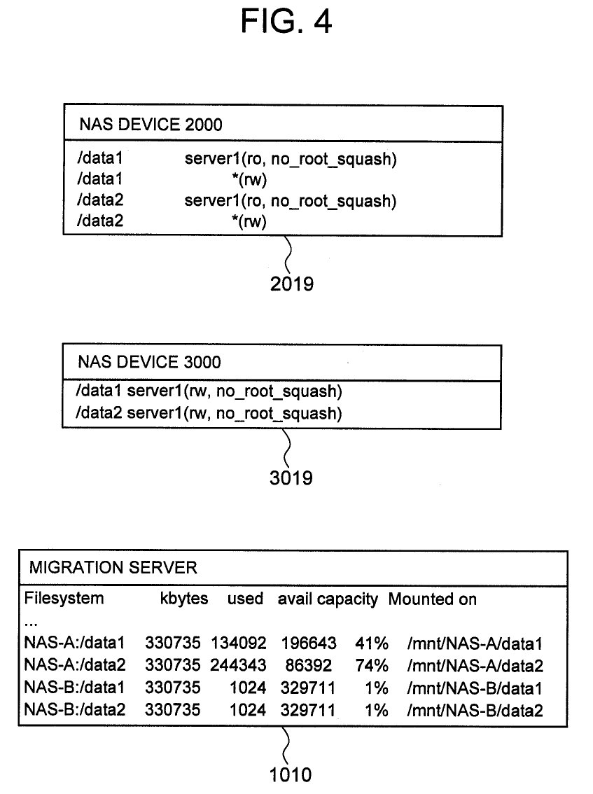

FIG. 4 shows an example of NAS Share information 2019 (3019) stored by the NAS device 2000 (3000), and an example of NAS mount information 1010 stored by the migration server 1000.

The NAS Share information 2019 (3019) includes statements indicating what directories of the NAS device 2000 (3000) are shared by what devices under what access rights.

For example, the NAS Share information 2019 includes statements that mean that the directory “/data1” and the directory “/data2” are shared by the migration server 1000 (server 1), and statements “ro” that indicate that the migration server 1000 has read only access rights for each of the above directories. The statement no_root_squash” means that in NFS access is permitted with root authority. Also, the statements on the second and fourth lines mean that for the directory with the directory name “/data1” and the directory with the directory name “/data2” the client 4000 has Read and Write access rights.

Also, for example, the NAS Share information 3019 includes statements that mean that the directory “/data1” and the directory “/data2” are shared by the migration server 1000 (server 1), and statements “rw” that indicate that the migration server 1000 has read and write access rights for each of the above directories. The statement no_root_squash” means that in NFS access is permitted with root authority. Comparing NAS Share information 3019 with NAS Share information 2019 as shown on this figure, it can be seen that at the present time there is no need to permit the client 4000 to access the NAS device 3000.

The NAS mount information 1010 includes statements that indicate what shared directories of what NAS device are mounted in the local directories held by the migration server 1000. For example, the NAS mount information 1010 includes statements that mean that the directory “/date1” that is shared by NAS-A (NAS device 2000) is mounted in the local directory “/mnt/NAS-A/data1” of the migration server 1000.

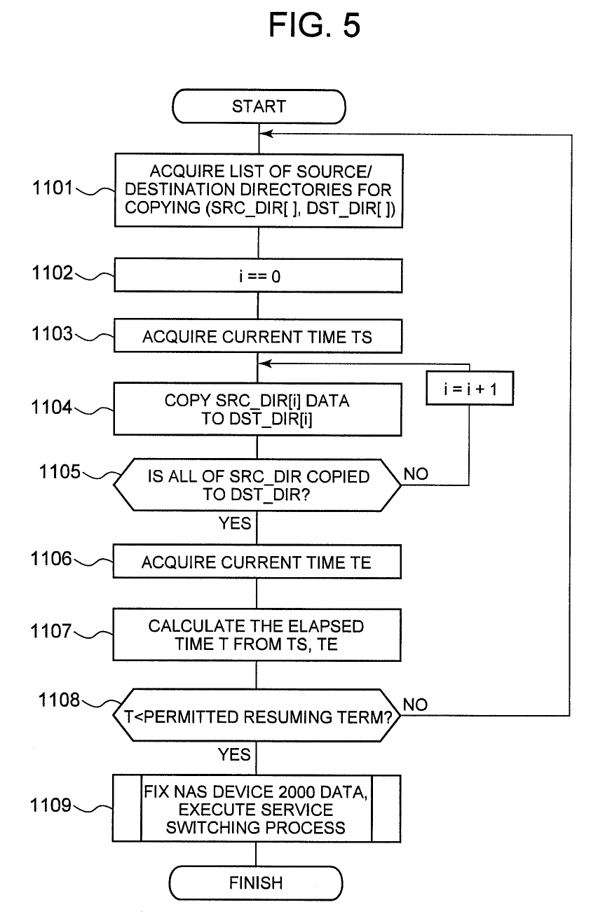

The following is an explanation using FIG. 5 of the flow of the processes carried out by the data migration program 1008 that is executed by the migration server 1000. Using the data migration program 1008, it is possible to achieve low cost and safe migration, without the need for compatibility between the NAS devices 2000 and 3000. The present embodiment is explained using NFS as an example, but with CIFS substantially the same procedure may be used (even if the format of the NAS Share information 2019 (3019) and so on, is different).

In Step 1101, the data migration program 1008 acquires the list of source and destination directories for copying. Here, for example “/mnt/NAS-A/data1”, “/mnt/NAS-A/data2” are listed as values (for example path names) expressing the source directories, and “/mnt/NAS-B/data1”, “/mnt/NAS-B/data2” are listed as values (for example path names) expressing the destination directories. In other words, in this process flow, there are two source directories “/mnt/NAS-A/data1”, “/mnt/NAS-A/data2”, and two destination directories “/mnt/NAS-B/data1”, “/mnt/NAS-B/data2” that are the copy destinations for the two source directories.

In Step 1102, the data migration program 1008 sets the variable i to zero.

In Step 1103, the data migration program 1008 obtains the current time TS. Here, for example TS=“9/6 0:10”.

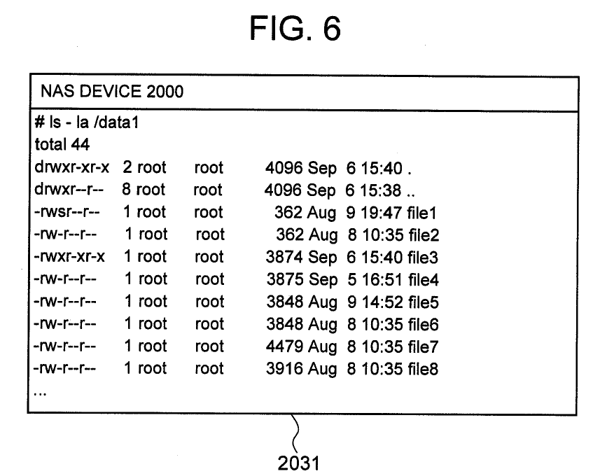

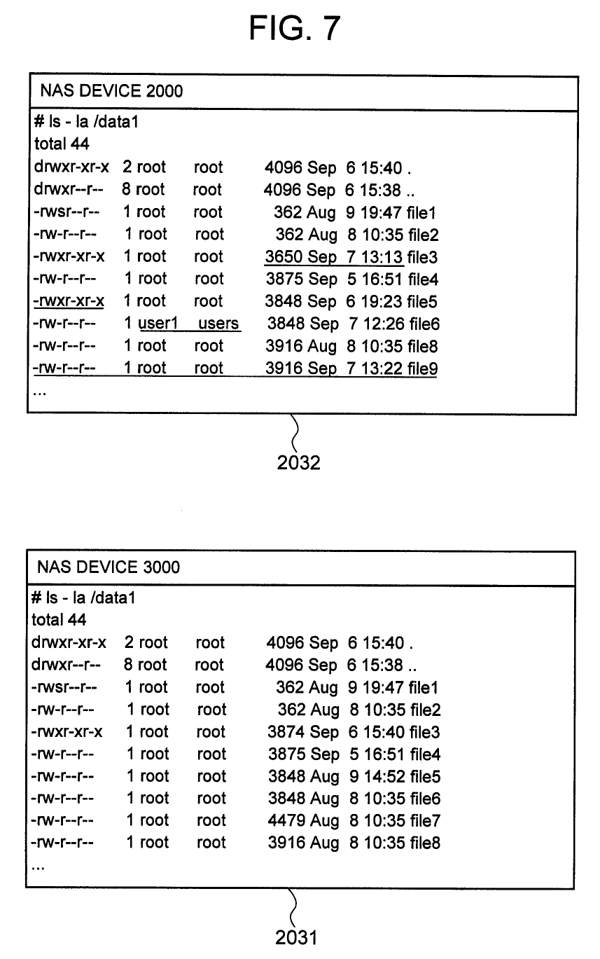

In Step 1104, the data migration program 1008 copies the data corresponding to “src_dir[i] ” to dst_dir[i]. At his stage i=0, so there is one source directory “/mnt/NAS-A/data1” corresponding to src_dir[0], and one destination directory “/mnt/NAS-B/data1” corresponding to “dst_dir[0]. In FIG. 6, a configuration example is shown for current data 2031 (in other words, the data 2031 existing at the current time TS that was obtained in Step 1103) within the source directory “/mnt/NAS-A/data1”. The destination directory “/mnt/NAS-B/data1” is currently empty, so the data migration program 1008 copies all the data 2031 as it is to the destination directory “/mnt/NAS-B/data1”. Then the content of the destination directory “/mnt/NAS-B/data1” becomes as shown in the bottom of FIG. 7 (data 2031). During this time, the NAS device 2000 receives Read/Write requests with respect to the directory “/data1” from the client 4000. When Write requests are received, data is added or data is modified in the directory “/data1”, in accordance with the Write request.

In Step 1105, the data migration program 1008 checks whether there are src_dir, dst_dir to be copied (in other words, whether the initial copy is completed or not). Here it is necessary to copy the data from one more source directory “/mnt/NAS-A/data2” to one more destination directory “/mnt/NAS-B/data2”. Therefore, the variable i is set to 1 (in other words, the variable i is incremented by 1), and the copy process returns to Step 1104 and continues. When the copy process is completed for all the src_dir, dst_dir, the routine proceeds to Step 1106.

In Step 1106, the data migration program 1008 obtains the current time TE. Here, for example TE=“9/8 10:23”.

In Step 1107, the data migration program 1008 calculates the difference between the current time TS and the current time TE, in other words, calculates the time T that passed from Steps 1104 to 1105. Here, T=58 hours 13 minutes.

In Step 1108, the data migration program 1008 determines whether T is less than a permitted resuming time determined in advance. The permitted resuming time is a length of time for which receipt of Read/Write requests from the client 4000 may be suspended. Specifically, the permitted resuming time is the length of time that NFS/CIFS service is suspended in order to copy the necessary data to the NAS device 3000 after fixing the data to be migrated. The permitted resuming time is a value input by for example the input device 1005 or similar. Here, the permitted resuming time is taken to be 10 hours. Therefore, as T is not less than 10 hours, the routine returns to Step 1101, and the same process is repeated.

Incidentally, after step 1105, the data of /data1 stored in the NAS device 3000 was the data 2031 as shown in the bottom of FIG. 7. The time required for the previous Steps 1104 to 1105 was T (58 hours 13 minutes), but during this time the client 4000 was able to access the source, or the NAS device 2000. In other words, the NAS device 2000 received Write requests with respect to the source directory “/data1” from the client 4000, and if Write requests were received there will be newly added/modified files in the source directory “/data1”. The top of FIG. 7 shows the data 2032 in the NAS device 2000 including the added/modified data. Comparing the data 2032 with the data 2031, the following are different.

(a) File modification date and time (mtime): file3

(b) File permission: file5

(c) File owner: file6

(d) Newly added file: file9

(e) Deleted file: file7

At least one of, for example, modification date and time, permission, owner, and size may be adopted as file attributes. The migration server 1000 can determine added/modified data by comparing the data of the source NAS and the destination NAS. The data migration program 1008 checks for the changes (a) through (e) above by obtaining the file lists for src_dir, dst_dir from the NAS device 2000, and copies the necessary data (in other words, the added/modified data) to the NAS device 3000. Therefore, here the content of the new data 2032 is copied to the data 2031 of the NAS device 3000. In other words, the differential data associated with the changes (a) through (e) above is copied from the source directory to the destination directory (in other words, the first differential copy is executed).

By repeatedly carrying out the copy, the amount of data to be copied becomes smaller with each succeeding copy, so that the copying time T becomes shorter. Then, by repeating the differential data copy several times, at a certain time the time T required for the differential copy will become less than the permitted resuming term. When the data migration program detects that T<permitted resuming term, the routine proceeds to Step 1109.

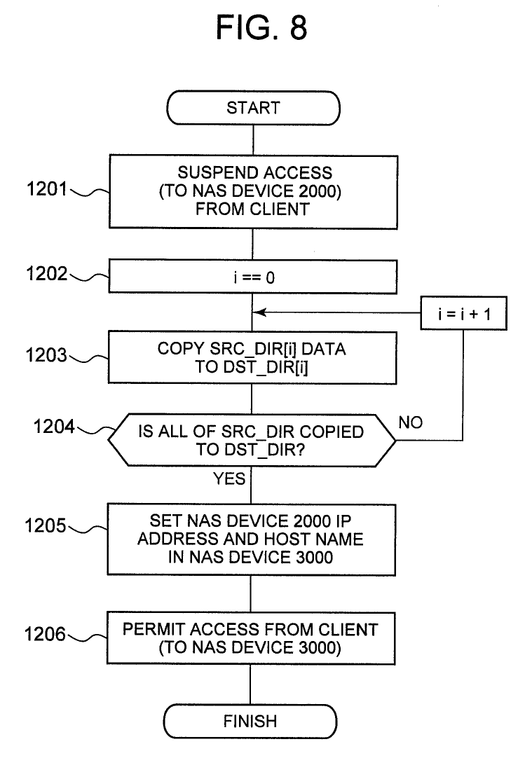

In Step 1109, the data migration program 1008 fixes the data in the NAS device 2000, and executes a service switching process. This is explained in detail using FIG. 8.

In Step 1201, the data migration program 1008 suspends access by the client 4000 to the NAS device 2000. Specifically, for example the data migration program 1008 deletes lines 2, 4 of the NAS Share information 2019 shown in FIG. 4, and restarts the NFS service. In this way, the client 4000 becomes unable to Read/Write data to the NAS device 2000, and the data in the NAS device 2000 is fixed.

In Step 1202, the data migration program 1008 sets the variable i to 0.

In Steps 1203 through 1204, the data migration program 1008 copies the src_dir data (in other words, the differential data) to dst_dir. Here, the data in the source directory “/mnt/NAS-A/data1” whose data has been fixed is copied to the destination directory “/mnt/NAS-B/data1”. In the same way, the data in the source directory “/mnt/NAS-A/data2” is copied to the destination directory “/mnt/NAS-B/data2”. In this way, the data in the directories “/data1” and “/data2” in the NAS device 2000 and the data in the directories “/data1”, “/data2” in the NAS device 3000 are the same.

In Step 1205, the data migration program 1008 replaces the IP address and host name of the NAS device 2000 with those of the NAS device 3000.

In Step 1206, the data migration program 1008 changes the access permission in the NAS device 3000 so that the client 4000 may access the NAS device 3000. Specifically, for example, the data migration program 1008 adds lines 2, 4 of the NAS Share information 2019 in FIG. 4 as it is to the NAS Share information 3019, and restarts the NFS service. In this way, the client 4000 can access the NAS device 3000 that contains the data of the NAS device 2000. Then finally, a person such as the administrator may remove the migration server 1000 and the NAS device 2000 which have become unnecessary.

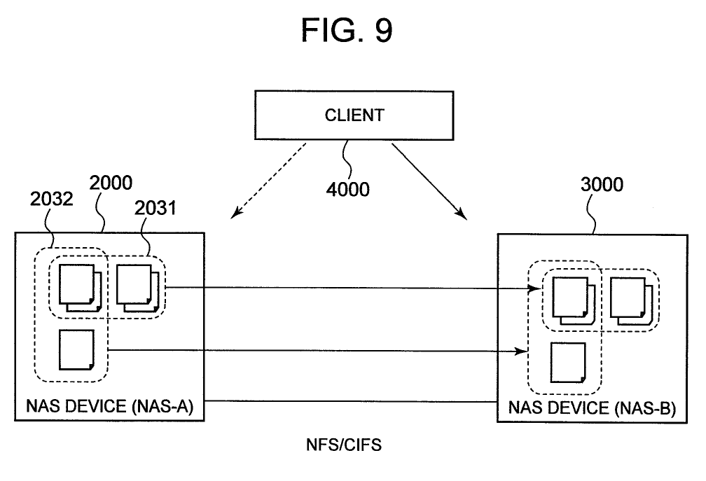

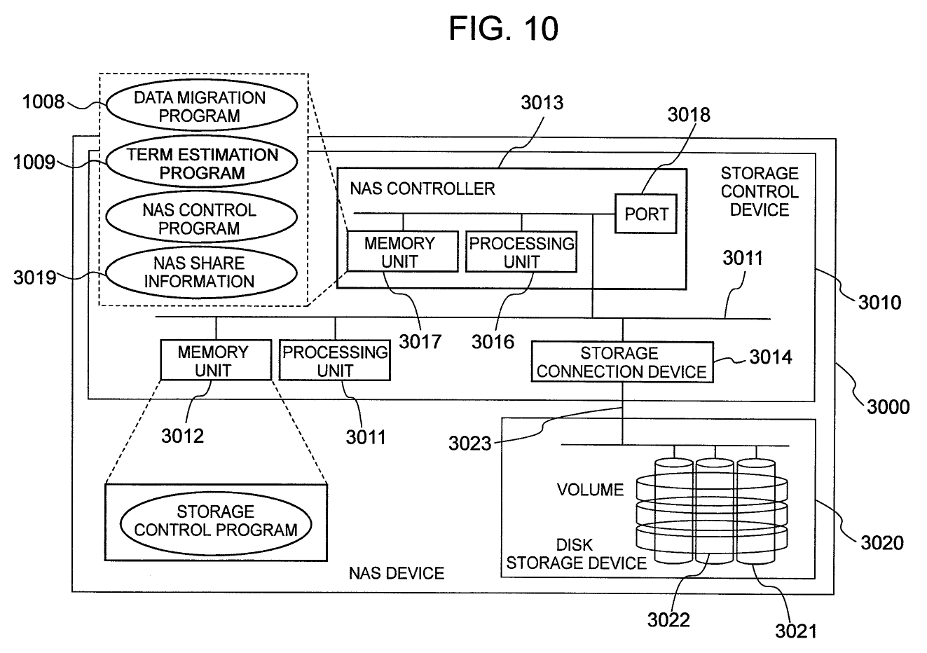

In the embodiment as described above, the data migration program 1008 is stored in the migration server 1000. However the data migration program 1008 may instead be stored in the destination NAS device, or the NAS device 3000 (see for example FIGS. 9 and 10).

Also, in the embodiment as described above, a plurality of shared directories “/data1” and “/data2” were copied by a single migration server 1000. However, the load may be dispersed among a plurality of migration servers and/or a plurality of processes. Specifically, a migration server 1000a may be responsible for copying the data in directory “/data1”, and a migration server 1000b may be responsible for copying the data in directory “/data2”. Also, copying the data in directory “/data1” may be executed by data migration program 1008a of the migration server 1000, and copying the data in directory “/data2” may be executed by data migration program 1008b of the migration server 1000.

Incidentally, generally the time required for data migration (hereafter referred to as “migration term”) depends on the volume of data to be copied, and tends to be a long time. Therefore, estimating in advance the migration term is important for properly designing the data migration system.

Therefore, estimating the migration term can be further implemented in the embodiment.

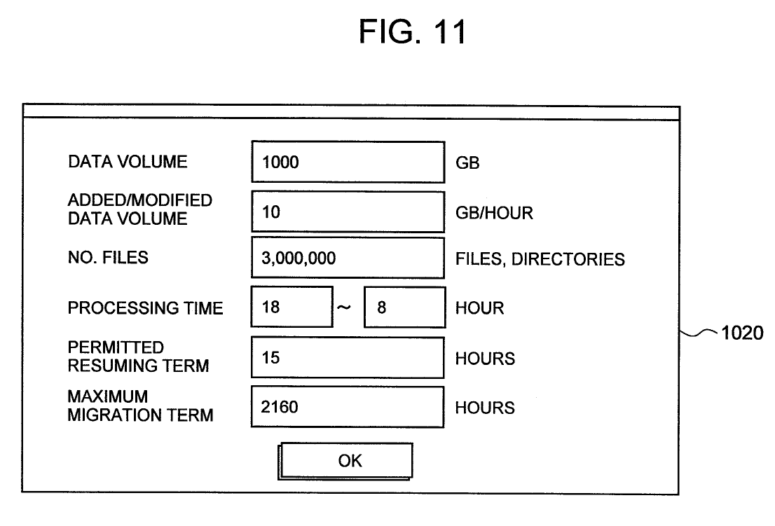

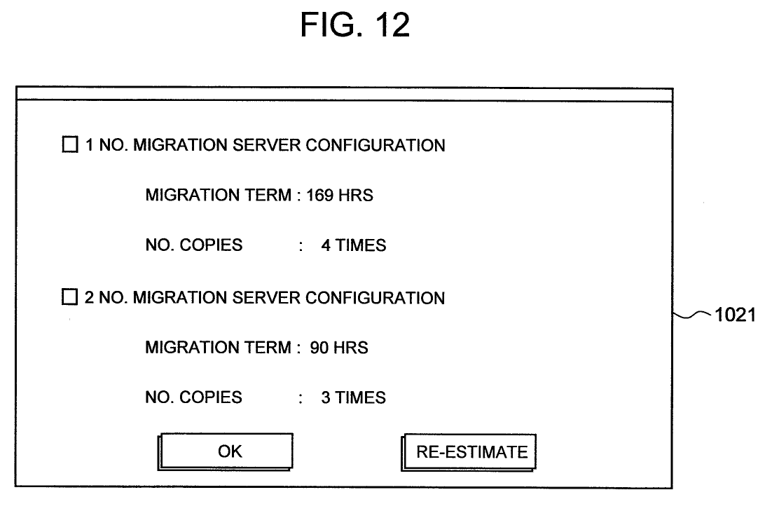

In estimating the migration term, a migration term estimation program 1009 displays the data input screen 1020 for estimating shown as an example in FIG. 11. In the screen 1020, a user inputs a plurality of information elements necessary for estimating the migration term, such as for example the data volume (the volume of data in the source NAS device 2000 that is to be copied), the volume of added/modified data (the volume of data added/modified per unit time), the number of files, processing time (the best time period for carrying out the data copying), the permitted resuming term, and the maximum migration term. After these information elements are input, the migration term estimation program 1009 calculates the migration term separately for each migration server, and displays the estimated migration term for each migration server, as shown in FIG. 12. In this way, users such as the migration operator, designer, or operation administrator can understand in advance how long the migration term will be.

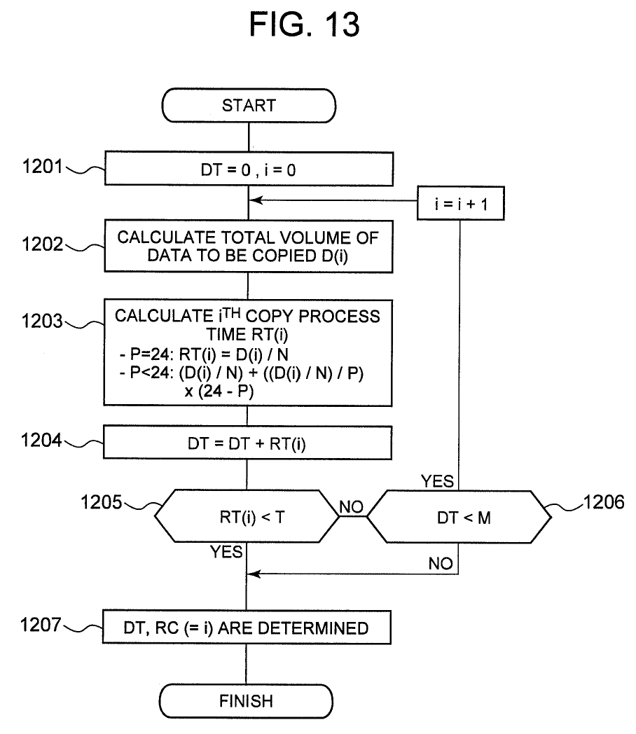

The following is an explanation of the process flow executed by the migration term estimation program 1009, using FIG. 13.

In Step 1201, the migration term estimation program 1009 sets the variables DT (overall copy processing time) to 0 and to 1 respectively.

In Step 1202, the migration term estimation program 1009 calculates the volume of data to be copied D(i) in the i^{th} copy process. If i=0, this corresponds to the first copy process by the data migration program 1008 as stated previously (in other words, corresponds to the initial copy), therefore D(1) is the data volume 1000 GB input in FIG. 11.

In Step 1203, the migration term estimation program 1009 calculates the i^{th} required copy time RT(i). RT(i) may be calculated by dividing the volume to be copied D(i) by the actual copying capacity N. N may for example be taken to be the Write performance of the migration server 1000 and the NAS device 3000 by NFS/CIFS. This is because with NFS and CIFS, Write tends to be the bottleneck rather than Read. Here, N=50 Mbps (megabyte per second) for example.

Also, in calculating the required copying time RT(i), it is necessary to take into consideration the processing time P shown in FIG. 11. The processing time P, for example, takes into consideration the load and the like on the source NAS device 2000, and operation limitations, such as for example the copying process may be executed from 18:00 hours until 08:00 hours the following day. In the example shown in FIG. 11, the processing time is from 18:00 hours until 08:00 hours the following day, so P=14 hours. If P<24, there is an operational limitation, so the length of time over which the copying process can be executed is limited. If P is 24, it means 24 hours per day. Therefore, it means that it does not matter how much processing time P is allocated to the copying process in one day.

In this case, the formula for calculation is the following Formula (I)

RT(i)=(D(i)−N)+(D(i)−N)+P)×(24−P) (1)

Here, P<24, so RT(1) (1000 GB÷50 Mbps)+((1000 GB÷50 Mbps)÷14)×(24−14)=74 hours. If P=24, there is no operational limitation, so RT(1)=D(i) N (in other words, 1000 GB÷50 Mbps=44 hours).

In Step 1204, the migration term estimation program 1009 calculates DT=DT+RT(1). Here DT=0+74 hours=74 hours.

In Step 1205, the migration term estimation program 1009 checks whether RT(1) is less than t. The parameter t indicates the permitted resuming term, and here is 15 hours, as shown in FIG. 11. Here RT(1)=74 hours, which is not less than t, so the routine proceeds to Step 1206.

In Step 1206, the migration term estimation program 1009 checks whether the overall copying time DT is less than M. M is the maximum migration term for data migration. Here M is 2,160 hours (3 months), as shown in FIG. 11. Currently DT 74 hours, which is less than M, so i is set to 2 (in other words, i is incremented by 1), and the routine returns to Step 1202.

Continuing from Step 1202 to 1206, the following occurs. Here, if i is 2 or greater, the volume of data D(i) to be copied is (previous required copying time)×(volume of data added/modified per unit time U).
Second time copying: RT(2)=(74 hours×10 GB/hour÷50 Mbps)+((74 hours×10 GB/hour÷50 Mbps)÷14)×(24−14)=54 hours (DT=74+54 hours=128 hours, which is less than M)
Third time copying: RT(3)=(54 hours×10 GB/hour+50 Mbps)+((54 hours×10 GB/hour÷50 Mbps)÷14)×(24−14)=28 hours (DT=128+28 hours=156 hours, which is less than M)
Fourth time copying: RT(4)=(28 hours×10 GB/hour÷50 Mbps)+((28 hours×10 GB/hour÷50 Mbps)÷14)×(24−14)=12 hours (DT=156+12 hours=168 hours, which is less than M)

From the above, the required copying time RT(4) in the fourth time copying is less than the 15 hours permitted resuming term t (Step 1205), and DT and RC (=i) which indicates the number of copying times are determined (Step 1206). In this way, the estimated migration term is made clear, and the designers (users) of the migration system can properly design the data migration system.

Regarding the processing time P, executing the data migration process within the processing time P can be achieved by providing a function to start and terminate the copying process at predetermined start and finish times in the data migration program 1008.

Also, if DT is not less than M (no at Step 1206), the routine proceeds to Step 1207.

Also, as shown in FIG. 10, the migration term estimation program 1009 may be provided in the NAS device 3000.

Also, although not particularly explained in detail, the migration term estimation program 1009 may execute the estimation as described above in accordance with the number of servers.

### Second Embodiment

During the data migration process, a Read load is applied to the source NAS device 2000. The NAS device 2000 is in the normal operating state and being accessed by the client 4000, so there is a possibility that the access performance by the client 4000 could be reduced by this load.

Therefore, in this second embodiment the following function is added to the data migration program 1008. In other words, while data is being copied, the performance information of the NAS device 2000 is constantly monitored, and when a predetermined threshold value (for example, a value input at the input device 1005, or similar) is exceeded, the data copying speed is adjusted.

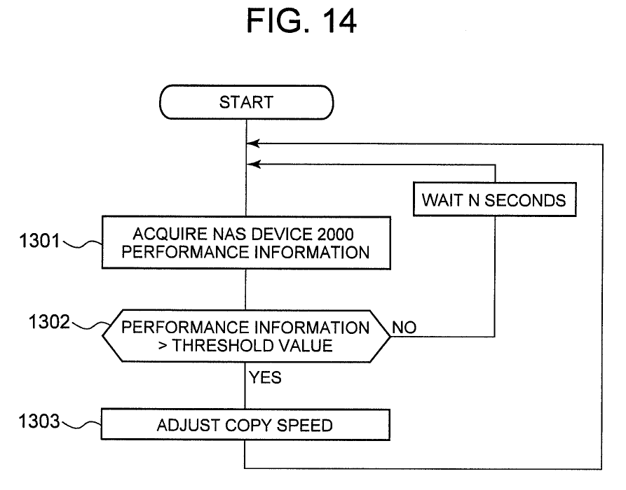

The following is an explanation of the process flow in FIG. 14. This process flow is executed, for example, during Step 1104 of FIG. 5.

In Step 1301, the data migration program 1008 acquires NAS device 2000 performance information. Performance information can include, for example, CPU usage rate, memory usage rate, port traffic volume, and other information to indicate the load on the NAS device 2000, and can be obtained by, for example, SNMP or similar.

In Step 1302, the data migration program 1008 checks whether the performance information obtained in Step 1301 exceeds a predetermined threshold. For example, assume the performance information obtained in Step 1301 is a CPU usage rate of 50%. If the predetermined threshold value is 60%, there is a wait of n seconds, then the routine returns to Step 1301. If the threshold value is 40%, the routine proceeds to Step 1303.

In Step 1303, the data migration program 1008 adjusts the data copying speed. Specifically, speed adjustment can be achieved by for example making the NFS/CIFS writing block size smaller, or setting a rate limit on the port traffic volume. Then, the routine returns to Step 1301, and the above process is repeated.

The above process continues until Step 1104 in FIG. 5 is completed. In this way, even if the load on the source NAS device 2000 increases and access by the client is affected, by adjusting the data copying speed the load is reduced and the effect on the client can be minimized.

### Third Embodiment

In a third embodiment of the present invention, a snapshot acquisition function is added to the data migration program 1008. In the third embodiment, the data migration program 1008 can execute the data copying by the following flow.

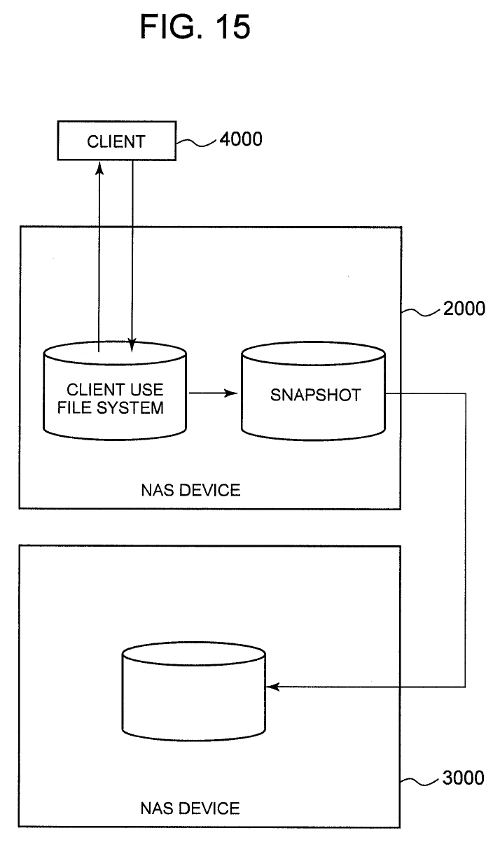

(1) As shown in FIG. 15, the data migration program 1008 obtains a snapshot of the volume (file system) in which the data that is to be copied is stored in the source NAS device 2000. The area where the snapshot is stored may be, for example, a separate logical volume with the same capacity as the volume corresponding to the file system in the memory of the NAS device 2000 or the migration server 1000.

(2) The data migration program 1008 shares the data included in the snapshot using NFS/CIFS.

(3) The data migration program 1008 reads all the data included in the snapshot from the area of memory that contains the snapshot, and copies the read data to the destination directory in the destination NAS device 3000. In this way the initial copy is completed.

(4) If the required copying time for the initial copy is less than the permitted resuming term, the data migration program 1008 fixes the data, obtains a snapshot of also the fixed data, reads the data from the snapshot, and writes the data to the destination NAS device 3000. On the other hand, if the required copying time for the initial copy exceeds the permitted resuming term, the data migration program 1008 executes a differential data copy. Specifically, for example, the data migration program 1008 obtains a snapshot of the differential data (added/modified data) in the source NAS device 2000, reads the differential data included in the snapshot, and writes the read data to the destination directory of the destination NAS device 3000.

(5) If the copying time required for the differential copy in (4) is less than the permitted resuming term, the data migration program 1008 fixes the data, obtains a snapshot of the fixed data, reads data from the snapshot, and writes the data to the destination NAS device 3000. On the other hand, if the copying time required for the differential copy exceeds the permitted resuming term, the data migration program 1008 executes the differential data copy as explained in (4).

According to the third embodiment, data is read, not from the actual logical volume (actual volume) in which the data that is accessed by the client 4000 is stored, but from a snapshot.

Several preferred embodiments of the present invention have been explained above. However, these were examples for explaining the present invention, and the scope of the present invention is not limited to only these embodiments. The present invention may be implemented in many other forms. For example, instead of fixing the data in the NAS device 2000 when the time required for copying is less than the permitted resuming term, other conditions may be adopted, such as when the number of copying times exceeds or is less than a predetermined threshold, and so on. Also, to fix the data, as an alternative to stopping both read and write requests, as a minimum write requests may be stopped.

What is claimed is:

1. A control device that controls the migration of data from a first NAS device to a second NAS device, comprising:
a copy execution unit that carries out an initial data copy by reading an initial data group comprising all the data stored in a first storage area of the first NAS device from the first storage area and writing the initial data group to a second storage area of the second NAS device, and after the initial data copy or a differential data copy is completed, carries out a differential data copy by reading a differential data group comprising one or more data corresponding to the differential from the data group read in the previous initial data copy or differential data copy, from the first storage area and writes the differential data group to the second storage area; and
a copy control unit that at least every time a differential data copy is completed, determines whether data fixing conditions are satisfied, and if the data fixing conditions are satisfied, causes the first NAS device to suspend writing from a client device to the first storage area, and causes the copy execution unit to execute a final differential data copy.

2. The control device according to claim 1, wherein the copy control unit measures a required copying time for the initial data copy or the differential data copy, and the data fixing conditions are satisfied when the measured required copying time is equal to or less than a predetermined first threshold value.

3. The control device according to claim 1, wherein after the final differential data copy is completed, the copy control unit sets, in the second NAS device, information elements necessary for access by the client device to the first storage area of the first NAS device, to allow access by the client device to the second NAS device to start.

4. The control device according to claim 1, wherein in each copy operation the copy execution unit obtains a snapshot of the data to be copied in the first NAS device, and reads the data from the snapshot.

5. The control device according to claim 2, further comprising an estimating unit that receives input of a plurality of data elements including the size of the initial data group, the size of the differential data group generated per unit time and the first threshold value, estimates a required copying time for each copying based on the input size of the initial data group and the input size of the differential data group generated per unit time, and if the estimated required copying time is equal to or less than the input first threshold value, calculates a migration term required from the start of the initial data copy to the end of a final data copy, with the copy operation whose estimated required copying time is equal to or less than the input first threshold value being taken to be the final data copy operation.

6. The control device according to claim 5, wherein the copy execution unit is configured to execute the copying in one or more permissible time spans in a predetermined period of time, the input plurality of information elements include the length of one or more of these time spans, and the estimation unit calculates the migration term based on the one or more time spans.

7. The control device according to claim 1, further comprising an acquisition unit that acquires at least one of a first load information that represents the load on the first NAS device and a second load information that represents the load on the second NAS device, wherein when the load represented by the acquired load information exceeds a second threshold value, the copy control unit slows the copying speed.

8. The control device according to claim 1, wherein the control device is a third device connected to the first NAS device and the second NAS device, and further comprises a mounting unit that mounts the first storage area of the first NAS device and the second storage area of the second NAS device.

9. The control device according to claim 1, wherein the control device is the second NAS device, and further comprises a mounting unit that mounts the first storage area of the first NAS device.

10. The control device according to claim 1, wherein the first storage area is a first shared directory, the second storage area is a second shared directory, the copy control unit measures a required copying time for the initial data copy or the differential data copy, the data fixing conditions are satisfied when the measured required copying time is equal to or less than a predetermined first threshold value, the copy control unit sets an IP address and a host name of the first NAS device in the second NAS device to allow access by the client device to the second shared directory of the second NAS device to start when the final differential data copy is completed, and the differential data is at least one of the data that is stored in the first shared directory but not stored in the second shared directory, and the data that is stored in both the first shared directory and the second shared directory but for which the attribute of the data have been changed.

11. A method for controlling the migration of data from a first NAS device to a second NAS device, comprising the steps of:
carrying out an initial data copy by reading an initial data group comprising all the data stored in a first storage area of the first NAS device from the first storage area and writing the initial data group to a second storage area of the second NAS device;
carrying out a differential data copy by reading a differential data group comprising one or more data corresponding to the differential from the data group read in the previous initial data copy or differential data copy, from the first storage area and writing the differential data group to the second storage area after the initial data copy or the differential data copy is completed;
receiving writing from a client device to the first storage area by means of the first NAS device while the initial data copy or the differential data copy is being carried out; and
determining whether data fixing conditions are satisfied at least every time a differential data copy is completed, and if the data fixing conditions are satisfied, causing the first NAS device to suspend writing from the client device to the first storage area, and executing a final differential data copy.

12. The control method according to claim 11, further comprising the step of measuring a required copying time for the initial data copy or the differential data copy, wherein the data fixing conditions are satisfied when the measured required copying time is equal to or less than a predetermined first threshold value.

13. The control method according to claim 11, further comprising the step of setting, in the second NAS device, information elements necessary for access by the client device to the first storage area of the first NAS device, to allow access by the client device to the second NAS device to start after the final differential data copy is completed.

14. The control method according to claim 11, wherein in each copy operation, a snapshot of the data to be copied is obtained in the first NAS device, and the data is read from the snapshot.

15. The control method according to claim 12, further comprising the steps of:
receiving in advance, before the start of the initial data copy, input of a plurality of data elements including the size of the initial data group, the size of the differential data group generated per unit time and the first threshold value;
estimating a required copying time for each copying based on the input size of the initial data group and the input size of the differential data group generated per unit time; and
calculating a migration term required from the start of the initial data copy to the end of a final data copy, taking the copy operation whose estimated required copying time is equal to or less than the input first threshold value to be the final copy operation, if the estimated required copying time is equal to or less than the input first threshold value.

16. The control method according to claim 15, wherein if the copying is executed in one or more permissible time spans in a predetermined period of time, the input plurality of information elements include the length of the one or more time spans, and the migration term is calculated based on the one or more time spans.

17. The control method according to claim 11, further comprising the steps of: acquiring at least one of a first load information that represents the load on the first NAS device and a second load information that represents the load on the second NAS device; and slowing the copying speed when the load represented by the acquired load information exceeds a second threshold value.

18. The control method according to claim 11, further comprising the steps of: mounting the first storage area of the first NAS device and the second storage area of the second NAS device; and carrying out copying from the mounted first storage area to the mounted second storage area in the initial data copy and the differential data copy.

19. The control method according to claim 11, further comprising the steps of: mounting the first storage area of the first NAS device; and carrying out copying from the mounted first storage area to the second storage area in the initial data copy and the differential data copy.

20. The control method according to claim 11, wherein the first storage area is a first shared directory, the second storage area is a second shared directory, a required copying time for the initial data copy or the differential data copy is measured, the data fixing conditions are satisfied when the measured required copying time is equal to or less than a predetermined first threshold value, an IP address and a host name of the first NAS device are set in the second NAS device to allow access by the client device to the second shared directory of the second NAS device to start when the final differential data copy is completed, and the differential data is at least one of the data that is stored in the first shared directory but not stored in the second shared directory, and the data that is stored in both the first shared directory and the second shared directory but for which the attribute of the data have been changed.
